(19) United States
(12) Patent Application Publication
(10) Pub. No.: US 2011/0008210 A1
(43) Pub. Date: Jan. 13, 2011

(54) BIOSENSOR AND A RELATED MANUFACTURING METHOD

(75) Inventors: Marika Kurkinen, Tyrnava (FI); Jukka Hast, Kiviniemi (FI); Markus Tuomikoski, Kempele (FI); Markku Kansakoski, Oulu (FI); Harri Kopola, Oulu (FI)

Correspondence Address: YOUNG & THOMPSON, 209 Madison Street, Suite 500, Alexandria, VA, 22314, US

(73) Assignee: VALTION TEKNILLINEN TUTKIMUSKESKUS, Espoo (FI)

(21) Appl. No.: 12/918,843

(22) PCT Filed: Feb. 23, 2009
(86) PCT No.: PCT/FI09/50146

§ 371 Date: Aug. 23, 2010

(30) Foreign Application Priority Data
Feb. 21, 2008 (EP) PCT/EP2008/052114

(51) Int. Cl. G01N 21/76; H01J 9/227

(52) U.S. Cl. 422/52; 156/67

(57) ABSTRACT

A biosensor platform for a biosensor adapted to detect one or more predetermined target analytes in a sample, includes a waveguide for transporting light emitted by a light source, at least one light source including an OLED, for incoupling light to the waveguide, the light source being arranged on the waveguide, a binding site including immobilized biorecognition material capable of binding to the target analytes, the binding site positioned relative to the waveguide such that evanescent field triggered by the light propagating in the waveguide extend to the binding site, a microfluidic layer including one or more microfluidic cavities for conveying the sample past the binding site to enable at least part of the target analytes of the sample to bind to the immobilized biorecognition material. The biosensor platform is configured to enable, when least part of the target analytes are bound to the immobilized biorecognition material, fluorescent markers associated with the bound target or other analytes to be excited by the evanescent field so as to emit fluorescence detectable by a detector.

### FIELD OF THE INVENTION

Generally the invention pertains to biosensors. In particular the invention concerns evanescent field excitation—based biosensors incorporating microfluidic cavities.

### BACKGROUND

Biosensors are devices that are typically adapted to detect predetermined biological or chemical analyte(s) such as various (infectious) agents, drugs, toxins, nucleic acids, carcinogens, proteins, etc. with a help of a biological component that is sensitive to the analyte. Immunoassays are tests often employed in biosensors; they especially utilize the fact that an antibody can act as a biosensing biological material as it reacts to the corresponding antigen. In this context the reaction usually includes binding of the antibody to the antigen. Also other types of biosensors are available. Biosensors generally further include a transducer and a detector, which convert the sensitivity reaction to some other form, e.g. into electrical, thermal, or optical signal, and recognize the converted signal, respectively.

FIG. 1 discloses an exemplary block diagram of a typical biosensor wherein bio-elements 104 comprise biorecognition material capable of binding to predetermined target analytes 102 of a sample, whereupon the transducer 106 converts an indication of the binding reaction(s) into a preferred destination format, e.g. an electrical signal 108, such that the detector 110 may determine the desired property relative to the analytes 102 in the sample.

Demand of “lab-on-a-chip”—type biosensors for different environmental, food safety, point-of-care and home diagnostics applications has considerably increased during the last decade. The produced solutions have, however, often failed in terms of obtained accuracy, reliability, usability, sensitivity, response time, and/or processibility. For example, the achieved sensing results may have been accurate enough but the price of the biosensor has also exceeded a tolerable level due to complex manufacturing phase, or vice versa.

Microfluidics is usually related to miniature size arrangements for conveying and controlling limited fluid volumes. Traditionally microfluidics has been applied in printing technology, e.g. inkjet printers, but recently the feasibility thereof has also been investigated in biosensors.

Publication WO2007043005 discloses an optical sensor including several material layers such as a bottom substrate layer and an optical waveguide layer with incoupling structure for external light source in a form of a grating. A sample containing the analyte in unknown concentration and a known amount of a compound that comprises luminescent labelling may be brought into contact with the surface of the optical sensor such that the luminescent labelled and unlabelled molecules compete for the binding sites at their immobilised detector substances. A maximum luminescence signal is achieved in this assay configuration when the sample contains no analyte. In one embodiment a cover plate is applied containing channels for guidance of the analyte and other liquids necessary for carrying out the measurement in a closed microfluidic system.

### SUMMARY OF THE INVENTION

The objective is to provide an enhanced biosensor overcoming or at least alleviating the defects found in prior art arrangements.

The objective is met by a biosensor platform in accordance with the present invention cleverly integrating many or even all necessary elements of a full biosensing arrangement together in a novel manner.

Namely, in accordance with an aspect of the present invention, a biosensor platform for a biosensor adapted to detect one or more predetermined target analytes in a sample, comprises
a waveguide for transporting, preferably by substantially total internal reflection, light emitted by a light source,
at least one light source including an organic light emitting diode (OLED) arranged on said waveguide for incoupling light to the waveguide, the light source being, for example, printed on the waveguide or provided with a layer on the waveguide,
a binding site comprising immobilized biorecognition material capable of binding to the target analytes, said binding site positioned relative to the waveguide such that evanescent field triggered by the light propagating in the waveguide extends to the binding site, where the binding site may optionally be specifically arranged on the waveguide surface facing the microfluidic layer, and
a microfluidic layer comprising one or more microfluidic cavities for conveying the sample past said binding site so as to enable at least part of the target analytes of the sample to bind to the immobilized biorecognition material,

wherein said biosensor platform is further configured to enable, when said at least part of the target analytes are bound to the immobilized biorecognition material, fluorescent markers associated with the bound target or other analytes to be excited by the evanescent field so as to emit fluorescence detectable by a detector.

In another aspect, the biosensor platform as described above or further equipped with a detector is manufactured by a method, wherein at least one of the waveguide, microfluidic layer, light source, detector, and an aggregate entity comprising at least two of the aforesaid elements is produced utilizing a roll-to-roll technique.

In one embodiment of the biosensor platform in accordance with the present invention the binding site is arranged on a surface of the waveguide that faces the microfluidic layer.

In one embodiment the waveguide comprises substantially optically transparent material. The refractive index of the material is selected higher than the index of the surrounding materials such that the total internal reflection phenomenon may take place with incident angles surpassing the associated critical angle. Embodiments of feasible materials are given hereinafter. The waveguide may be a slab waveguide or a guided waveguide, for instance.

In one embodiment the fluorescent markers include fluorophores, for example.

In certain embodiment the fluorescent markers such as fluorophores are coupled to mobile biorecognition material arranged up-front into said microfluidic layer, whereupon the mobile biorecognition material may bind to the analytes of the input sample; thus the fluorescent markers may indirectly connect to the analytes as well. In another embodiment the target analytes themselves include fluorescent material, which mitigates or completely removes the need to utilize additional fluorescent markers. In a further embodiment, the fluorescent markers are directly or indirectly, i.e. via intermediate elements, associated with target analytes prior to conveying the sample to the biosensor platform. Yet in a further embodiment a competitive approach is taken and the fluorescent markers are coupled to competitive analyte entities relative to the target analyte entities of the sample such that the amount of emitted fluorescence (now by the fluorescent markers of the competitive analytes) is inversely proportional to the amount of target analytes in the sample. In this embodiment the competitive analytes may be arranged to the microfluidic layer during the manufacturing, or arranged in contact with the sample prior to introducing the sample to the biosensor platform.

In one embodiment the detector is an external detector. In an alternative embodiment, the detector is integrated with the sensor platform. It may be printed on the waveguide and/or the microfluidic layer, or provided as a separate layer coupled to the waveguide, for example.

In one embodiment the biosensor platform is configured to act as an immunoassay. The biorecognition material may include antibody for a predetermined antigen selected as a target analyte, for example.

The light source is advantageously an OLED, which is an organic light source. In one embodiment the light source is particularly a PLED (polymer light emitting diode). In alternative embodiments various other polymeric and/or even inorganic light sources may be applied.

In one embodiment the biosensor platform consists of two layers, i.e. the waveguide and the microfluidic layer. The light source such as OLED may be cleverly integrated with the waveguide, i.e. it may be inkjetted, gravure printed, flexo printed or screen printed thereon, for example. In another embodiment the light source, such as OLED, is provided on a film laminated with the waveguide.

The utility of the present invention arises from a plurality of issues. The obtained product may provide accurate, reliable, selective, affordable and rapid results in the context of biosensing. Still, the product may be disposable, thin, light, and simple to use. It may be manufactured utilizing large-scale and efficient production methods such as roll-to-roll processing. Separately constructed, typically inefficient optically functional structures such as gratings for incoupling light from external light sources may be omitted. The utilized materials (waveguide, OLED, microfluidic layer, detector, etc) may be flexibly case-specifically, e.g. depending on the target analytes, determined prior to the manufacturing phase without diverging from the basic principles disclosed herein. Thus the product may be easily tailored for different use scenarios. In some applications a detector with desired capabilities may be integrated with the product for providing ready-for-use complete package whereas in other scenarios an external detector may be preferred. Namely, the latter option enables scaling the use expenses after manufacturing the basic platform; by utilizing an expensive but precise dedicated CCD-analysator, better detection results may be obtained, but in some cases, considering e.g. home diagnostics, even the use of consumer electronics (e.g. a camera phone with related software) is possible and provides sufficient accuracy.

Various embodiments of the present invention are disclosed in the dependent claims.

### BRIEF DESCRIPTION OF THE RELATED DRAWINGS

Next the invention is described in more detail with reference to the appended drawings in which

FIG. 1 discloses a typical biosensor from a functional standpoint.

FIG. 2a discloses an embodiment of the present invention from a structural standpoint.

FIG. 2b discloses an embodiment of the present invention from a functional standpoint.

FIG. 3 illustrates principles of roll-to-roll processing in the context of the present invention.

### DETAILED DESCRIPTION OF THE EMBODIMENTS

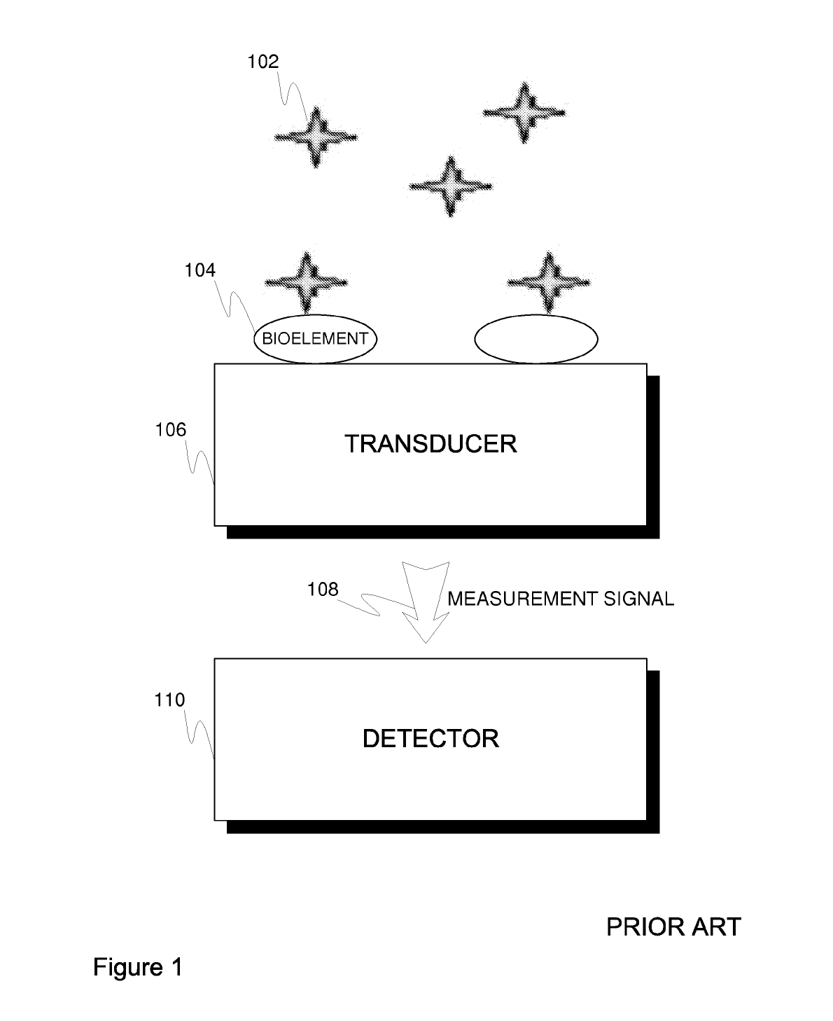

FIG. 1 was already contemplated hereinbefore in connection with the analysis of related art.

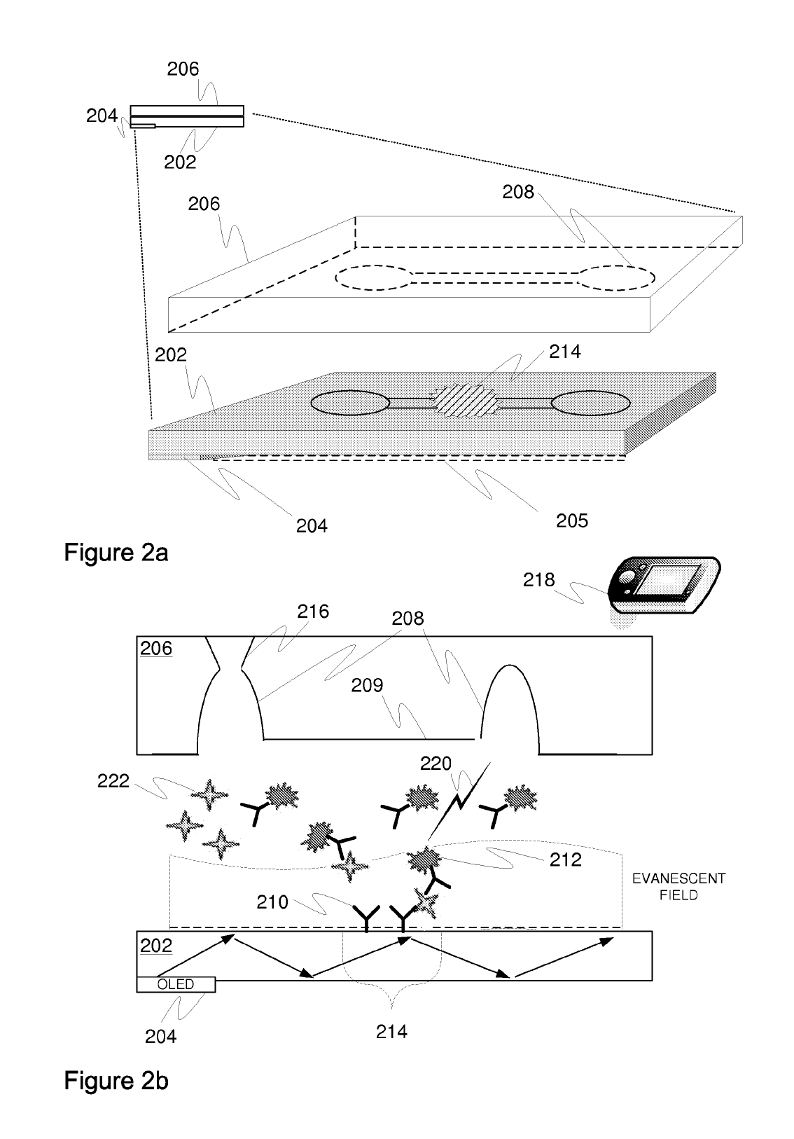

FIG. 2a discloses, by way of example only, a partially exploded view of an embodiment in accordance with the biosensor platform of the present invention. 202 denotes a waveguide, in this application especially a lightguide that is configured to transport light by internal reflection therewithin, preferably by substantially total internal reflection. 206 denotes a microfluidic layer comprising one or more microfluidic cavities 208 that may incorporate portions with smaller diameter, e.g. ‘pipes’ or ‘tubes’, both expressions considered as equivalent hereinafter, or portions having a larger diameter, e.g. ‘chambers’. The cavities 208 optionally include further internal structures that may together or independently define one or more forms selected from a group consisting of a pole, column, ledge, hole, projection, block, funnel, membrane and screen. Also other forms may be constructed. There may be only one source chamber, one destination chamber, and a tube portion between, or a plurality of source chambers, destination chambers, and/or intermediate tubes, either in parallel or serially connected, may be arranged. The source chamber may include a funnel to input sample (not shown) or utilize other structures or means for acquiring it. The tubes may exploit e.g. capillary action for obtaining the sample from an adjacent chamber. Alternatively or in addition, the destination or some other chamber may be provided with material, such as paper, that has good absorbtion capabilities in relation to the utilized fluid (sample). Further, one or more pumping arrangements including one or more microfluidic pumps may be utilized for transporting the fluid in the cavities 208. The sample may refer to a biofluid such as certain body fluid (e.g. blood), or some other fluid, for example.

Position of the cavities 208 of the microfluidic layer 206 on the waveguide 202, when these two 202, 206 are put together, is specifically highlighted by the shadowing effect on the waveguide surface in the figure, but it shall be noted that this has been done for illustration and clarification only and in true implementation forming e.g. cavity structures also on the waveguide 202 may not be necessary. Meanwhile, an area called a binding site 214 is arranged on a predetermined area of the waveguide 202 surface facing the microfluidic layer 206. In this particular embodiment there is a single binding site 214 facing the tube portion between two chambers, but in alternative embodiments a different number, e.g. two or more, of binding sites 214 (or ‘sub-sites’ of an aggregate site) may be applied and also positioned in a variety of ways relative to the microfluidic layer 206 and cavities 208 therein. An array of different biorecognition areas comprising e.g. different biorecognition material, i.e. binding sites 214 and/or sub-sites, may be provided in order to detect several different analytes in the sample by a single sensor platform and preferably even in one go, for example.

The biosensor platform may be expanded to a biosensor by integrating a detector element, e.g. as a detection layer on top of the microfluidic layer 206 or below the lightguide 202, for example.

As the evanescent field decays rather quickly, i.e. the range for fluorescent marker excitation may only be about 100 nm, for example, it is typically advantageous to position the binding site close, e.g. maximally close, to the source of evanescent radiation, in this case the waveguide 202.

The waveguide 202 and/or the microfluidic layer 206 may consist of or at least include polymeric material selected from a group consisting of: PET, PEN, PMMA, PC, and COC. Alternatively, use of other materials is possible.

In case the microfluidic cavities are hot embossed or otherwise produced as grooves, recesses, apertures, etc, in the microfluidic layer 206, thermoplastic properties of the layer 206 shall be appropriately selected. Considering the requirements set by roll-to-roll processing, layer thickness shall be kept low, e.g. under about 500 μm. The microfluidic layer 206 shall naturally be at least slightly thicker than the incorporated cavities to enable accommodating such in the first place.

Broken line 205 refers to optional, light source(s)—incorporating, layer. Alternatively, one or more light sources 204 such as OLEDs or variations thereof may be directly integrated with the waveguide 202 by printing them thereon, for example. If a plurality of light sources are used, they may either be of the same or different size, and be positioned adjacent to and/or separate from each other. The decisive parameter(s) for determining the type, dimensions, and/or positioning of the light sources may depend on the preferred light intensity and illumination pattern within the waveguide 202. For example, the OLED may include e.g. two electrodes having one or more organic or polymeric layers disposed between them.

One or more reflective surfaces or other optically functional elements may be provided as coatings and/or surface relief forms, for example, on the waveguide 202 for supplementary light directing and/or coupling purposes.

Binding of the biorecognition material to the site 214 may be performed by a non-covalent method, e.g. passive adsorbtion, or by a covalent method applicable to the exploited material. The material may be initially spread to the associated surface by dispensing, inkjetting, gravure printing, flexo printing, screen printing, etc.

FIG. 2b further visualizes one embodiment of the biosensor platform in accordance with the present invention and the arrangement of FIG. 2a from a functional standpoint, again with a partially exploded view.

The binding site 214 is provided with immobilized biorecognition material 210 (in the figure depicted as ‘y’-shaped forms), such as antidotes in the context of immunoassays. The material 210 is configured to bind to the related analytes (analyte entities, mutually different or similar) 222, e.g. (infectious) agents, drugs, toxins, nucleic acids, carcinogens, proteins, etc. The analytes 222 are brought to the vicinity of the binding site 214 by microfluidic cavity structures including e.g. tubes 209 and/or chambers 208. 216 denotes a funnel, an example of a means for inputting the sample to the microfluidic cavity system. Alternatively, the funnel 216 may be formed to the waveguide 202. The light source 204, such as an OLED, emits light to propagate within the waveguide 202 by reflection as visualized in the figure by arrows.

212 denotes a fluorescent marker (sharp-edged roundish form) attached to a mobile biorecognition material. The markers 212 may now, via the associated biorecognition material capable of binding to the analytes 222, also indirectly couple to and be thus associated with the analytes 222, which may still bind to the immobile biorecognition material of the binding site 214. Upon binding to the site 214, the evanescent field, illustrated as a wavy rectangle with broken line, reaches the marker 212 and excitates it such that the marker 212 emits fluorescence (note the symbol 220), which may be detected either by external 218 or embedded detector(s). Either a dedicated detector or even common consumer electronics (camera or camera phone with analysis software) may be exploited for detection and optionally subsequent further analysis purposes.

This was an example of a non-competitive approach in which the amount of fluorescence detected is directly proportional to the concentration of target analytes 222 in the sample. As explained hereinbefore, competitive approaches may be alternatively applied. In one feasible competitive approach, competitive analytes comprising fluorescent markers/material are also arranged, either initially or together with the sample, into the microfluidic cavities, such that either a target analyte 222 or a competitive analyte, but not both, may be bound to each immobile biorecognition material entity of the binding site 214, the amount of detected fluorescence being thus inversely proportional to the concentration of target analytes 222 in the sample.

In one embodiment, the immobile biorecognition material of the binding site 214 comprises antigen capable of binding to a predetermined antibody (analyte), or a group of different antibodies, of the sample. The microfluidic cavities may be supplied with second antibody provided with fluorescent material and capable of binding to the antigen-antibody complex such that the amount of detected fluorescence is directly proportional to the concentration of target analytes (now associated with both first and second antibodies) in the sample. This type of solution may be utilized in (in vitro) allergy testing, for example.

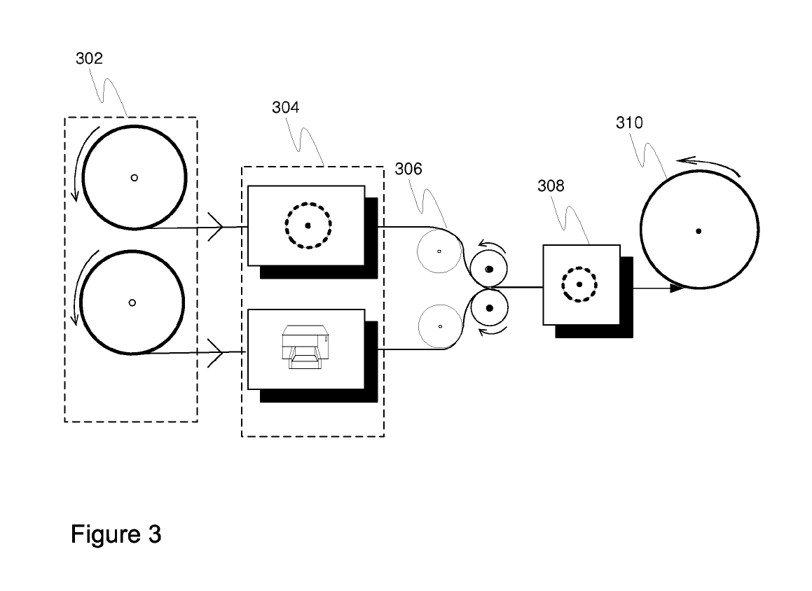

FIG. 3 illustrates an example of a production method for providing biosensors in accordance with the embodiments of the present invention.

The figure shows some basic principles of roll-to-roll (or ‘reel-to-reel’) processing wherein preferred elements, e.g. optical and/or electrical ones, may be deposited on a continuous roll substrate that may be both long and wide and proceed either in constant or dynamic speed from a source roll to a destination roll during the procedure. The roll-to-roll manufacturing therefore advantageously enables rapid and cost effective manufacturing of products such as the biosensor platform in accordance with the present invention. During the roll-to-roll process several material layers may be joined together ‘on the fly’, and the aforesaid elements may be structured on them prior to, upon, or after the actual joining instant. The source layers and the resulting band-like aggregate entity may be further subjected to various treatments during the process. Layer thicknesses (thinner layers are generally preferred) and optionally also other properties should be selected so as to enable roll-to-roll processing to a desired extent.

Source rollers 302 may provide the material layers forming at least the microfluidic layer and the waveguide, which serve as substrates for microfluidic cavities and binding site/light source(s), such as OLED(s), respectively. 304 denotes optional processing of one or more of the layers prior to entering to the joining phase 306. Such processing may generally include actions such as heating, (heat) embossing, coating, printing components (e.g. OLED), introducing (spreading/binding, for example) the biorecognition material by e.g. non-covalent/covalent method on the waveguide, etc. At 306 the layers are joined together after which further processing 308, such as adding more material layers/coating (e.g. detector), printing components (e.g. OLED), may take place before the resulting aggregate element, i.e. the biosensor platform or the full biosensor, is rolled up to the destination roll 310 for storage and optionally transportation. Nevertheless, also the joining phase 306 may itself incorporate other processing tasks such as printing or embossing functionalities. The symbols shown in the processing entities 304, 306 were meant for illustration only and should not be construed as limiting the versatility of implementable functions therein.

Correspondingly, the solution of FIG. 3 shall be ultimately considered as an exemplary embodiment only and in different embodiments both varying number and varying nature of rollers, used layers, processing steps, etc. may be applied in order to produce a biosensor platform in accordance with the present invention. Instead of executing multiple operations in a single roll-to-roll instance, it is possible to divide the overall manufacturing method into several, and optionally roll-to-roll, subphases comprising only one or more parts of the overall method. Also completely other types of methods than roll-to-roll may be used for producing the platform.

The scope of the invention can be found in the following claims. Notwithstanding the various embodiments described hereinbefore in detail, a person skilled in the art will appreciate the fact that different modifications may be introduced to the explicitly disclosed solutions without diverging from the fulcrum of the present invention as set forth in this text and defined by the independent claims.

1. A biosensor platform for a biosensor adapted to detect one or more predetermined target analytes in a sample, comprising
a waveguide (202) for transporting, optionally by substantially total internal reflection, light emitted by a light source,
at least one light source (204) including an organic light emitting diode (OLED) arranged on said waveguide for incoupling light to the waveguide, such as printed on the waveguide or provided with a layer on the waveguide,
a binding site (214) comprising immobilized biorecognition material capable of binding to the target analytes, said binding site positioned relative to the waveguide such that evanescent field triggered by the light propagating in the waveguide extends to the binding site, said binding site being optionally specifically arranged on a surface of the waveguide facing the microfluidic layer, and
a microfluidic layer (206) comprising one or more microfluidic cavities for conveying the sample past said binding site so as to enable at least part of the target analytes of the sample to bind to the immobilized biorecognition material,
wherein said biosensor platform is further configured to enable, when said at least part of the target analytes are bound to the immobilized biorecognition material, fluorescent markers associated with the bound target or other analytes to be excited by the evanescent field so as to emit fluorescence detectable by a detector.

2. The biosensor platform of claim 1, further comprising mobile biorecognition material provided with said fluorescent markers.

3. The biosensor platform of claim 2, wherein said mobile biorecognition material is configured to bind to the target analytes of the sample.

4. The biosensor platform of claim 1, further comprising one or more competitive analytes relative to the target analytes, the competitive analytes being provided with fluorescent markers and capable of binding to the immobilized biorecognition material.

5. The biosensor platform of claim 1, wherein said immobilized or mobile biorecognition material comprises antibody for a predetermined antigen, said antigen being defined as said target analyte.

6. The biosensor platform of claim 1, wherein said immobilized biorecognition material of the binding site comprises antigen capable of binding to predetermined antibody, or a group of antibodies, in the sample, said antibody or said group of antibodies of the sample being defined as said one or more target analytes.

7. The biosensor platform of claim 6, provided with additional antibody associated with said fluorescent markers and capable of binding to the antigen-antibody complexes formed on the binding site.

8. The biosensor platform of claim 1, wherein said microfluidic layer comprises at least one element selected from a group consisting of: a source chamber for receiving the sample, a funneling means for conveying the sample deeper in the layer, a tube for transporting the sample, an intermediate chamber for gathering the sample, and a destination chamber for gathering the sample after biorecognition phase.

9. The biosensor platform of claim 1, configured to apply capillary action in conveying the sample.

10. The biosensor platform of claim 1, wherein the microfluidic layer and/or the waveguide include at least one polymeric material optionally selected from a group consisting of: PET (polyethylene terephthalate), PEN (polyethylene naphthalate), PMMA (polymethyl methacrylate), PC (polycarbonate), and COC (cyclo-olefin copolymer).

11. The biosensor platform of claim 1, wherein layer thicknesses of the waveguide and/or the microfluidic layer are substantially equal or under about 500 μm.

12. The biosensor platform of claim 1, configured to detect a plurality of different target analytes.

13. A biosensor comprising the biosensor platform of claim 1 and a detector for measuring the emitted fluorescence.

14. The biosensor of claim 13, wherein said detector is external (218) to the platform.

15. The biosensor of claim 14, wherein said detector is a dedicated array detector, such as a CMOS- or CCD-based analysator, or a multi-purpose device, such as a consumer electronics apparatus provided with a camera.

16. The biosensor of claim 13, wherein said detector is integrated with the biosensor platform.

17. A method for manufacturing a biosensor platform as defined by claim 1, wherein at least one of said waveguide, microfluidic layer, light source, detector, binding site, and an aggregate entity comprising at least two of the aforesaid elements is produced utilizing a roll-to-roll technique.

18. The method of claim 17, wherein the light source is printed on the waveguide.

19. The method of claim 17, wherein at least part of said one or more microfluidic cavities are hot embossed to the microfluidic layer.

20. The method of claim 17, wherein said biorecognition material is spread to the binding site by dispensing, inkjetting, gravure printing, flexo printing, or screen printing.

21. The method of claim 17, wherein said biorecognition material is bound to the binding site by a non-covalent technique, passive adsorption, or by a covalent technique.
